(19) United States
(12) Patent Application Publication
(10) Pub. No.: US 2021/0284837 A1
(43) Pub. Date: Sep. 16, 2021

(54) POLYCARBONATE RESIN COMPOSITION AND MOLDED BODY

(71) Applicant: IDEMITSU KOSAN CO., LTD., Tokyo (JP)

(72) Inventors: Yasuhiro ISHIKAWA, Ichihara-shi, Chiba (JP); Aki YAMADA, Sodegaura-shi, Chiba (JP)

(73) Assignee: IDEMITSU KOSAN CO., LTD., Tokyo (JP)

(21) Appl. No.: 16/338,960

(22) PCT Filed: Oct. 3, 2017
(86) PCT No.: PCT/JP2017/035989

§ 371 Date: Apr. 2, 2019

(30) Foreign Application Priority Data
Oct. 7, 2016 (JP) 2016-199128

(51) Int. Cl. C08L 69/00; C08G 64/08; C08G 64/04; C08G 64/18; C08G 77/12; C08G 77/20; C08G 77/448; C08G 77/18; C08G 77/24; C08G 77/00

(52) U.S. Cl. CPC C08L 69/00; C08G 64/081; C08G 64/045; C08G 64/186; C08G 77/12; C08G 77/20; C08L 2203/206; C08G 77/18; C08G 77/24; C08G 77/80; C08L 2201/10; C08L 2205/02; C08G 77/448

(57) ABSTRACT

Provided are a polycarbonate-based resin composition, including: 99 mass % to 1 mass % of a polycarbonate-polyorganosiloxane copolymer (A) having a predetermined repeating unit (A-1) and predetermined constituent units (A-2) and (A-3); and 1 mass % to 99 mass % of a polycarbonate-based resin (B) except the polycarbonate-polyorganosiloxane copolymer (A), and a molded body thereof.

### TECHNICAL FIELD

The present invention relates to a resin composition and a molded body each including a polycarbonate-polyorganosiloxane copolymer.

### BACKGROUND ART

A polycarbonate resin has been widely used in various fields, such as the field of electrical and electronic equipment, and the field of automobiles, because the resin has high impact resistance, high chemical resistance, and high flame retardancy.

Meanwhile, in recent years, higher transparency and higher impact resistance have be required in terms of the designs and functions of various products. For example, a cellular phone button preferably has high transparency so that a letter or a number printed on its rear surface can be more clearly viewed. When a casing for a cellular phone, a digital camera, or a mobile personal computer is colored with a dye or painted from its rear surface, an appearance having a higher transparent feeling is preferably obtained. In addition, a material to be used in a window for a meter or the like requiring visibility or in a member requiring light transmissivity is required to have high transparency not only in terms of design but also in terms of functionality. Further, in order that a casing can resist, for example, impact at the time of its falling, the casing is simultaneously required to have high impact resistance while being transparent. Accordingly, various improvements have been attempted with a view to further improving the transparency and impact resistance of the polycarbonate resin. The blending of a typical polycarbonate resin with a polycarbonate-polyorganosiloxane copolymer (hereinafter sometimes referred to as “PC-POS copolymer”) has been known as one method for the improvement.

With regard to the PC-POS copolymer, it has been known that when a POS chain length in the PC-POS copolymer is short, the strength of the copolymer is hardly obtained, and hence a POS chain length above certain values is needed for obtaining impact resistance. Meanwhile, it has also been known that when the POS chain length is long, the transparency of the copolymer reduces, though the copolymer expresses satisfactory strength. In view of the foregoing, an investigation has been made to achieve both transparency and impact resistance in the PC-POS copolymer. In, for example, Patent Document 1, there is a disclosure that a PC-POS copolymer satisfying predetermined conditions, which is produced through the use of a polyorganosiloxane subjected to terminal modification with allylphenol or eugenol as a raw material and preferably by a predetermined production method, has excellent transparency while maintaining various characteristics, such as impact resistance. In addition, in Patent Document 2, there is a disclosure that a copolycarbonate obtained by polymerizing raw materials including an aromatic diol compound, a carbonate precursor, and a mixed siloxane compound having a predetermined structure can be simultaneously improved in low-temperature impact strength, transparency and fluidity that are characteristics contradictory to each other. In Patent Document 2, for example, a mixture of a PDMS terminal modified with 2-allylphenol (AP-PDMS) and a PDMS terminal modified with 2-methyl-1-butene hydroxybenzoate (MBHB-PDMS) is used as the mixed siloxane compound serving as a raw material for the copolycarbonate.

### CITATION LIST

### Patent Document

Patent Document 1: WO 2013/058214 A1

Patent Document 2: JP 2016-509106 A

### SUMMARY OF INVENTION

### Technical Problem

However, it has been found that when a typical polycarbonate resin is blended with a PC-POS copolymer, excellent transparency intrinsic to the polycarbonate resin is largely impaired, though its impact resistance is improved.

An object of the present invention is to provide a polycarbonate-based resin composition having high impact resistance and a low haze, and a molded body thereof.

### Solution to Problem

The inventors of the present invention have made extensive investigations, and as a result, have found that the object can be achieved by a resin composition including a polyorganosiloxane-polycarbonate copolymer having a specific constituent unit and a polycarbonate-based resin except the copolymer at a predetermined ratio.

That is, the present invention relates to the following items [1] to [14].

[1] A polycarbonate-based resin composition, comprising:

99 mass % to 1 mass % of a polycarbonate-polyorganosiloxane copolymer (A) having a repeating unit (A-1) represented by the following general formula (I), a constituent unit (A-2) represented by the following general formula (II), and a constituent unit (A-3) represented by the following general formula (III); and

1 mass % to 99 mass % of a polycarbonate-based resin (B) except the polycarbonate-polyorganosiloxane copolymer (A):

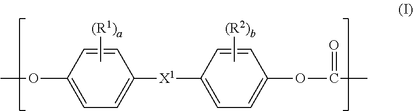

wherein R¹ and R² each independently represent a halogen atom, an alkyl group having 1 to 6 carbon atoms, or an alkoxy group having 1 to 6 carbon atoms, X¹ represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and “a” and “b” each independently represent an integer of from 0 to 4;

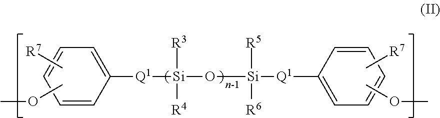

wherein R³ to R⁶ each independently represent a hydrogen atom or an alkyl group having 1 to 13 carbon atoms, R⁷ represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q¹ represents an alkylene group having 1 to 10 carbon atoms, and “n” represents an average chain length and represents from 30 to 70;

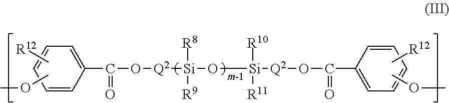

wherein R⁸ to R¹¹ each independently represent a hydrogen atom or an alkyl group having 1 to 13 carbon atoms, R¹² represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q² represents a divalent aliphatic group having 1 to 10 carbon atoms, and “m” represents an average chain length and represents from 30 to 70.

[2] The resin composition according to Item [1], wherein the polycarbonate-based resin (B) comprises an aromatic polycarbonate resin formed only of a repeating unit (B-1) represented by the following general formula (IV):

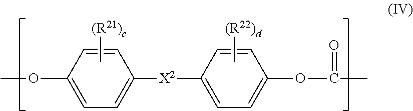

wherein R²¹ and R²² each independently represent a halogen atom, an alkyl group having 1 to 6 carbon atoms, or an alkoxy group having 1 to 6 carbon atoms, X² represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and “c” and “d” each independently represent an integer of from 0 to 4.

[3] The resin composition according to Item [1] or [2], wherein the polycarbonate-polyorganosiloxane copolymer (A) has a viscosity-average molecular weight of from 9,000 to 50,000.

[4] The resin composition according to any one of Items [1] to [3], wherein the polycarbonate-based resin (B) has a viscosity-average molecular weight of from 9,000 to 50,000.

[5] The resin composition according to any one of Items [1] to [4], wherein the resin composition has a viscosity-average molecular weight of from 12,000 to 30,000.

[6] The resin composition according to any one of Items [1] to [5], wherein a content of polyorganosiloxane blocks in the polycarbonate-polyorganosiloxane copolymer (A) is from 1 mass % to 12 mass %.

[7] The resin composition according to any one of Items [1] to [6], wherein a content of polyorganosiloxane blocks in the resin composition is from 0.1 mass % to 10 mass %.

[8] The resin composition according to any one of Items [1] to [7], wherein a molar ratio between a unit represented by the following general formula (q-1) and a unit represented by the following general formula (q-2) in the polycarbonate-polyorganosiloxane copolymer (A) is from 99/1 to 85/15:

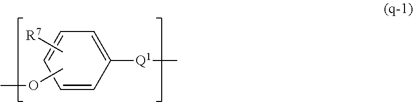

wherein R⁷ and Q¹ are identical to those described above;

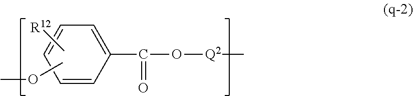

wherein R¹² and Q² are identical to those described above.

[9] The resin composition according to any one of Items [1] to [8], wherein in the general formula (I), X¹ represents an isopropylidene group and a=b=0.

[10] The resin composition according to any one of Items [1] to [9], wherein in the general formula (II), R³ to R⁶ each represent a methyl group.

[11] The resin composition according to any one of Items [1] to [10], wherein in the general formula (III), R⁸ to R¹¹ each represent a methyl group.

[12] The resin composition according to any one of Items [2] to [11], wherein in the general formula (IV), X² represents an isopropylidene group and c=d=0.

[13] The resin composition according to any one of Items [1] to [12], wherein a haze value of 3 mm thick plate produced from the resin composition, measured in conformity with ISO 14782, is 0.6 or less.

[14] A molded body, comprising the resin composition of any one of Items [1] to [13].

### Advantageous Effects of Invention

According to the present invention, the polycarbonate-based resin composition having high impact resistance and a low haze can be provided.

### BRIEF DESCRIPTION OF DRAWINGS

FIG. 1 is a graph obtained by plotting a correlation between the mass % of the PC-POS copolymer of each of resin compositions each having a viscosity-average molecular weight of around 17,500 (Examples 1 to 3, Comparative Examples 1, 3, and 5, and Comparative Examples 2, 4, and 6) and the haze thereof for each of PC-POS copolymer.

### DESCRIPTION OF EMBODIMENTS

A polycarbonate-based resin composition of the present invention is described in detail below. In this description, a specification considered to be preferred can be arbitrarily adopted, and a combination of preferred specifications can be said to be more preferred. The term “XX to YY” as used herein means “XX or more to YY or less.”

### [Polycarbonate-Based Resin Composition]

A polycarbonate-based resin composition of the present invention comprises: 99 mass % to 1 mass % of a polycarbonate-polyorganosiloxane copolymer (A) having a repeating unit (A-1) represented by the following general formula (I), a constituent unit (A-2) represented by the following general formula (II), and a constituent unit (A-3) represented by the following general formula (III); and 1 mass % to 99 mass % of a polycarbonate-based resin (B) except the polycarbonate-polyorganosiloxane copolymer (A):

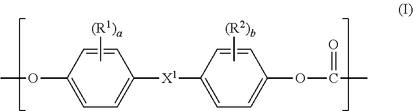

wherein R¹ and R² each independently represent a halogen atom, an alkyl group having 1 to 6 carbon atoms, or an alkoxy group having 1 to 6 carbon atoms, X¹ represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and “a” and “b” each independently represent an integer of from 0 to 4;

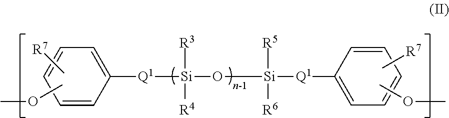

wherein R³ to R⁶ each independently represent a hydrogen atom or an alkyl group having 1 to 13 carbon atoms, R⁷ represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q¹ represents an alkylene group having 1 to 10 carbon atoms, and “n” represents an average chain length and represents from 30 to 70;

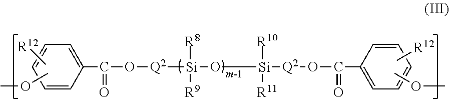

wherein R⁸ to R¹¹ each independently represent a hydrogen atom or an alkyl group having 1 to 13 carbon atoms, R¹² represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q² represents a divalent aliphatic group having 1 to 10 carbon atoms, and “m” represents an average chain length and represents from 30 to 70.

The polycarbonate-based resin composition of the present invention (hereinafter sometimes referred to as “resin composition of the present invention”) includes the predetermined component (A) and component (B). Accordingly, the composition has high impact resistance, and has a low haze and an excellent transparency.

According to Examples of Patent Document 2, it has been shown that the PC-POS copolymer of Comparative Example 1 using only a PDMS terminal modified with 2-methyl-1-butene hydroxybenzoate (MBHB-PDMS) as a siloxane compound has a high haze and a poor transparency, and its transparency and low-temperature impact strength are improved by using a PDMS terminal modified with 2-allylphenol (AP-PDMS) as a siloxane compound in combination with the MBHB-PDMS (Examples 1 to 4). In addition, it is found that the PC-POS copolymer of Comparative Example 2 using only the AP-PDMS as a siloxane compound has the lowest haze and the excellent transparency, as compared to those of Examples.

However, the inventors of the present invention have found the following unexpected effect: contrary to various characteristics of a PC-POS copolymer alone, when a resin composition including the PC-POS copolymer (A) and the polycarbonate-based resin (B) except the PC-POS copolymer (A) is produced, “transparency” in the case where a PC-POS copolymer using the MBHB-PDMS and the AP-PDMS as siloxane compounds in combination is used, is improved as compared to that in the case where a PC-POS copolymer using only the AP-PDMS as a siloxane compound is used.

The respective components to be incorporated into the resin composition of the present invention are described below.

### <Polycarbonate-Polyorganosiloxane Copolymer (A)>

The resin composition of the present invention includes the polycarbonate-polyorganosiloxane copolymer (A) having the repeating unit (A-1) represented by the general formula (I), the constituent unit (A-2) represented by the general formula (II), and the constituent unit (A-3) represented by the general formula (III). The repeating unit (A-1) is represented by the following general formula (I):

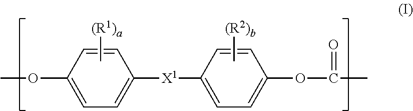

wherein R¹ and R² each independently represent a halogen atom, an alkyl group having 1 to 6 carbon atoms, or an alkoxy group having 1 to 6 carbon atoms, X¹ represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and “a” and “b” each independently represent an integer of from 0 to 4.

Examples of the halogen atom that R¹ and R² in the general formula (I) each independently represent include a fluorine atom, a chlorine atom, a bromine atom, and an iodine atom.

Examples of the alkyl group that R¹ and R² each independently represent include a methyl group, an ethyl group, a n-propyl group, an isopropyl group, various butyl groups (“various” means that a linear group and any branched group are included, and the same applies hereinafter), various pentyl groups, and various hexyl groups. An example of the alkoxy group that R¹ and R² each independently represent is an alkoxy group whose alkyl group moiety is the alkyl group described above.

The alkylene group represented by X¹ is, for example, a methylene group, an ethylene group, a trimethylene group, a tetramethylene group, a pentamethylene group, or a hexamethylene group, and is preferably an alkylene group having 1 to 5 carbon atoms. Examples of the alkylidene group represented by X¹ include an ethylidene group and an isopropylidene group. The cycloalkylene group represented by X¹ is, for example, a cyclopentanediyl group, a cyclohexanediyl group, or a cyclooctanediyl group, and is preferably a cycloalkylene group having 5 to 10 carbon atoms. The cycloalkylidene group represented by X¹ is, for example, a cyclohexylidene group, a 3,5,5-trimethylcyclohexylidene group, or a 2-adamantylidene group, and is preferably a cycloalkylidene group having 5 to 10 carbon atoms, more preferably a cycloalkylidene group having 5 to 8 carbon atoms.

Examples of the aryl moiety of the arylalkylene group having 7 to 15 carbon atoms or the arylalkylidene group having 7 to 15 carbon atoms represented by X¹ include aryl groups each having 6 to 14 ring-forming carbon atoms, such as a phenyl group, a naphthyl group, a biphenyl group, and an anthryl group.

“a” and “b” each independently represent an integer of from 0 to 4, preferably from 0 to 2, more preferably 0 or 1.

It is more preferred that in the general formula (I), X¹ represent an isopropylidene group and a=b=0.

The constituent unit (A-2) in the PC-POS copolymer (A) is represented by the following general formula (II):

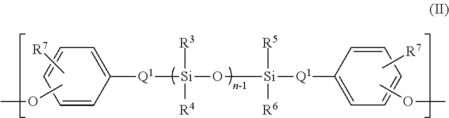

wherein R³ to R⁶ each independently represent a hydrogen atom or an alkyl group having 1 to 13 carbon atoms, R⁷ represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q¹ represents an alkylene group having 1 to 10 carbon atoms, and “n” represents an average chain length and represents from 30 to 70.

In the general formula (II), examples of the alkyl group having 1 to 13 carbon atoms that R³ to R⁶ each independently represent include a methyl group, an ethyl group, a n-propyl group, an isopropyl group, various butyl groups, various pentyl groups, various hexyl groups, various heptyl groups, various octyl groups, a 2-ethylhexyl group, various nonyl groups, various decyl groups, various undecyl groups, various dodecyl groups, and various tridecyl groups. Among them, R³ to R⁶ each preferably represent a hydrogen atom or an alkyl group having 1 to 6 carbon atoms, and it is more preferred that all of R³ to R⁶ each represent a methyl group.

Examples of the alkyl group having 1 to 6 carbon atoms represented by R⁷ include a methyl group, an ethyl group, a n-propyl group, an isopropyl group, various butyl groups, various pentyl groups, and various hexyl groups. Examples of the halogen atom represented by R⁷ include a fluorine atom, a chlorine atom, a bromine atom, and an iodine atom. An example of the alkoxy group having 1 to 6 carbon atoms represented by R⁷ is an alkoxy group whose alkyl group moiety is the alkyl group described above. In addition, examples of the aryl group having 6 to 14 carbon atoms represented by R⁷ include a phenyl group, a toluyl group, a dimethylphenyl group, and a naphthyl group.

Among them, R⁷ preferably represents a hydrogen atom or an alkoxy group having 1 to 6 carbon atoms, more preferably a hydrogen atom or an alkoxy group having 1 to 3 carbon atoms, still more preferably a hydrogen atom or a methoxy group, still further more preferably a hydrogen atom.

Examples of the alkylene group having 1 to 10 carbon atoms represented by Q¹ include a methylene group, an ethylene group, a trimethylene group, a tetramethylene group, a pentamethylene group, a hexamethylene group, a heptamethylene group, an octamethylene group, a nonamethylene group, and a decamethylene group. Among them, an alkylene group having 1 to 6 carbon atoms is preferred, an alkylene group having 2 to 4 carbon atoms is more preferred, and a trimethylene group is still more preferred.

In addition, the average chain length n in the general formula (II) is from 30 to 70, preferably from 30 to 60, more preferably from 30 to 50, still more preferably from 35 to 45. When the average chain length n is less than 30, the impact resistance of the resin composition becomes insufficient, and when the average chain length n is more than 70, the transparency thereof reduces and the handleability of the PC-POS copolymer (A) at the time of the production thereof decreases. The average chain length n is the average chain length of a POS block in the constituent unit (A-2), and is calculated by nuclear magnetic resonance (NMR) measurement.

A preferred mode of the constituent unit (A-2) may be, for example, a structure represented by the following formula (II-1):

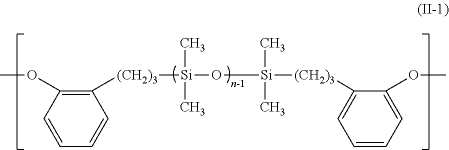

wherein “n” is identical to that described above.

The constituent unit (A-3) in the PC-POS copolymer (A) is represented by the following general formula (III):

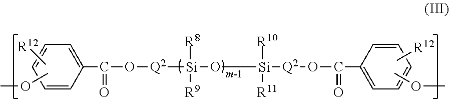

wherein R⁸ to R¹¹ each independently represent a hydrogen atom or an alkyl group having 1 to 13 carbon atoms, R¹² represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q² represents a divalent aliphatic group having 1 to 10 carbon atoms, and “m” represents an average chain length and represents from 30 to 70.

In the general formula (III), examples of the alkyl group having 1 to 13 carbon atoms that R⁸ to R¹¹ each independently represent include a methyl group, an ethyl group, a n-propyl group, an isopropyl group, various butyl groups, various pentyl groups, various hexyl groups, various heptyl groups, various octyl groups, a 2-ethylhexyl group, various nonyl groups, various decyl groups, various undecyl groups, various dodecyl groups, and various tridecyl groups. Among them, R⁸ to R¹¹ each preferably represent a hydrogen atom or an alkyl group having 1 to 6 carbon atoms, and it is more preferred that all of R⁸ to R¹¹ each represent a methyl group.

Examples of the alkyl group having 1 to 6 carbon atoms represented by R¹² include a methyl group, an ethyl group, a n-propyl group, an isopropyl group, various butyl groups, various pentyl groups, and various hexyl groups. Examples of the halogen atom represented by R¹² include a fluorine atom, a chlorine atom, a bromine atom, and an iodine atom. An example of the alkoxy group having 1 to 6 carbon atoms represented by R¹² is an alkoxy group whose alkyl group moiety is the alkyl group described above. Examples of the aryl group having 6 to 14 carbon atoms represented by R¹² include a phenyl group, a toluyl group, a dimethylphenyl group, and a naphthyl group.

Among them, R¹² preferably represents a hydrogen atom or an alkoxy group having 1 to 6 carbon atoms, more preferably a hydrogen atom or an alkoxy group having 1 to 3 carbon atoms, still more preferably a hydrogen atom.

The divalent aliphatic group having 1 to 10 carbon atoms represented by Q² is preferably a linear or branched divalent saturated aliphatic group having 1 to 10 carbon atoms. The number of carbon atoms of the saturated aliphatic group is preferably from 1 to 8, more preferably from 2 to 6, still more preferably from 3 to 6, still further more preferably from 4 to 6.

In addition, the average chain length m in the general formula (III) is from 30 to 70, preferably from 30 to 60, more preferably from 30 to 50, still more preferably from 35 to 45. When the average chain length m is less than 30, the impact resistance of the resin composition becomes insufficient, and when the average chain length m is more than 70, the transparency thereof reduces and the handleability of the component (A) at the time of the production thereof decreases. The average chain length m is the average chain length of a POS block in the constituent unit (A-3), and is calculated by NMR measurement.

A preferred mode of the constituent unit (A-3) may be, for example, a structure represented by the following formula (III-1)

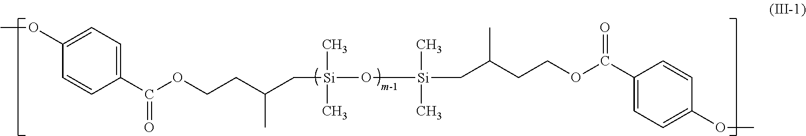

wherein “m” is identical to that described above.

The PC-POS copolymer (A) has all of the units (A-1) to (A-3). Particularly because the PC-POS copolymer (A) has both of the constituent units (A-2) and (A-3) each including a polyorganosiloxane block, when a resin composition including the polycarbonate-based resin (B) to be described later is produced, a resin composition having high impact resistance and a low haze can be obtained.

From the viewpoint of balance between the impact resistance and transparency of the composition, a molar ratio between a unit represented by the following general formula (q-1) and a unit represented by the following general formula (q-2) in the PC-POS copolymer (A) is preferably from 99/1 to 85/15, more preferably from 99/1 to 90/10, still more preferably from 99/1 to 92/8. The molar ratio can be calculated by NMR measurement.

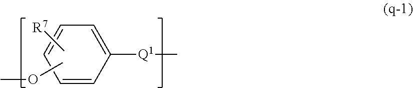

wherein R⁷ and Q¹ are identical to those described above;

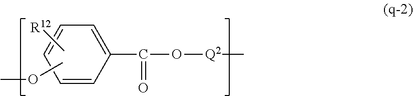

wherein R¹² and Q² are identical to those described above.

Although the PC-POS copolymer (A) may have a unit except the units (A-1) to (A-3), from the viewpoint of obtaining the effects of the present invention, the total amount of the units (A-1) to (A-3) in the case where the amount of all units in the PC-POS copolymer (A) is defined as 100 mass % is preferably 70 mass % or more, more preferably 80 mass % or more, still more preferably 90 mass % or more. Its upper limit is 100 mass %.

The average chain length of the polyorganosiloxane blocks in the PC-POS copolymer (A) is preferably from 30 to 70, more preferably from 30 to 60, still more preferably from 30 to 50, still further more preferably from 35 to 45. When the average chain length is 30 or more, the impact resistance of the resin composition is satisfactory, and when the average chain length is 70 or less, the transparency thereof and the handleability of the PC-POS copolymer (A) at the time of the production thereof are satisfactory. The average chain length is calculated by NMR measurement.

The total amount of the polyorganosiloxane blocks in the PC-POS copolymer (A) is preferably 1 mass % to 12 mass %, more preferably 2 mass % to 10 mass %, still more preferably 3 mass % to 8 mass %. When the total amount is 1 mass % or more, the impact resistance is satisfactory, and when the total amount is 12 mass % or less, the composition is excellent in transparency and economical efficiency.

The content of the POS blocks in the PC-POS copolymer (A) is calculated by NMR measurement, and specifically, can be measured by a method described in Examples.

The viscosity-average molecular weight (Mv) of the PC-POS copolymer (A) is preferably from 9,000 to 50,000, more preferably from 12,000 to 30,000, still more preferably from 14,000 to 25,000. When the viscosity-average molecular weight of the component (A) falls within the range, the impact resistance and chemical resistance of the composition become sufficient, and the fluidity thereof at the time of its molding becomes excellent.

The viscosity-average molecular weight (Mv) is a value calculated from the following Schnell's equation by measuring the limiting viscosity [η] of a methylene chloride solution at 20° C. (concentration: g/l).

[η]=1.23×10⁻⁵×MV^{0.83}

The PC-POS copolymers (A) may be used alone or in combination thereof. A case in which two or more of the PC-POS copolymers (A) are used is, for example, a case in which two or more of PC-POS copolymers different from each other in mass ratio among the units (A-1) to (A-3), average chain length of the polyorganosiloxane blocks, content of the polyorganosiloxane blocks, or viscosity-average molecular weight are combined.

### <Polycarbonate-Based Resin (B)>

The resin composition of the present invention includes 1 mass % to 99 mass % of the polycarbonate-based resin (B) except the PC-POS copolymer (A). The polycarbonate-based resin (B) is preferably an aromatic polycarbonate-based resin, more preferably an aromatic polycarbonate-based resin formed only of a repeating unit (B-1) represented by the following general formula (IV):

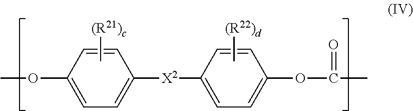

wherein R²¹ and R²² each independently represent a halogen atom, an alkyl group having 1 to 6 carbon atoms, or an alkoxy group having 1 to 6 carbon atoms, X² represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and “c” and “d” each independently represent an integer of from 0 to 4.

Specific examples of R²¹ and R²² include the same examples as those of the R¹ and the R², and preferred examples thereof are also the same as those of the R¹ and the R². R²¹ and R²² each more preferably represent an alkyl group having 1 to 6 carbon atoms or an alkoxy group having 1 to 6 carbon atoms. Specific examples of X² include the same examples as those of the X¹, and preferred examples thereof are also the same as those of the X¹. “c” and “d” each independently represent preferably from 0 to 2, more preferably 0 or 1. It is more preferred that in the general formula (IV), X² represent an isopropylidene group and c=d=0.

The viscosity-average molecular weight (Mv) of the polycarbonate-based resin (B) is preferably from 9,000 to 50,000, more preferably from 12,000 to 30,000, still more preferably from 14,000 to 25,000. When the viscosity-average molecular weight of the polycarbonate-based resin (B) falls within the range, the impact resistance and chemical resistance of the composition become sufficient, and the fluidity thereof at the time of its molding becomes excellent.

The polycarbonate-based resins (B) may be used alone or in combination thereof.

### (Method of Producing Polycarbonate-Polyorganosiloxane Copolymer (A))

The polycarbonate-polyorganosiloxane copolymer (A) to be used in the resin composition of the present invention can be produced by a known production method, such as an interfacial polymerization method (phosgene method), a pyridine method, or an ester exchange method. Particularly in the case of the interfacial polymerization method, the step of separating an organic phase containing the PC-POS copolymer and an aqueous phase containing an unreacted substance, a catalyst residue, or the like is facilitated, and the separation of the organic phase containing the PC-POS copolymer and the aqueous phase in each washing step based on alkali washing, acid washing, or pure water washing is also facilitated. Accordingly, the PC-POS copolymer is efficiently obtained.

The polycarbonate-polyorganosiloxane copolymer can be specifically produced by polymerizing a dihydric phenol represented by the following general formula (i), a carbonate precursor, a siloxane compound represented by the following general formula (ii), and a siloxane compound represented by the following general formula (iii) preferably according to the interfacial polymerization method:

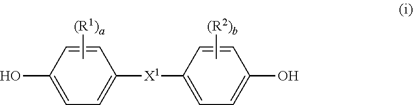

wherein R¹, R², “a”, “b”, and X¹ are identical to those described above;

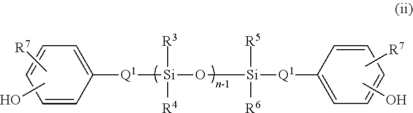

wherein R³ to R⁷, Q¹, and “n” are identical to those described above;

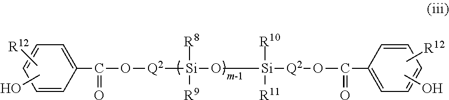

wherein R⁸ to R¹², Q², and “m” are identical to those described above.

The dihydric phenol represented by the general formula (i) and the carbonate precursor are raw materials forming the repeating unit (A-1) represented by the general formula (I) in the PC-POS copolymer (A).

Examples of the dihydric phenol represented by the general formula (i) include bis(hydroxyaryl)alkanes, bis(hydroxyaryl)cycloalkanes, dihydroxyaryl ethers, dihydroxydiaryl sulfides, dihydroxydiaryl sulfoxides, dihydroxydiaryl sulfones, dihydroxydiphenyls, dihydroxydiarylfluorenes, and dihydroxydiaryladamantanes. Those dihydric phenols may be used alone or as a mixture thereof.

Examples of the bis(hydroxyaryl)alkanes include bis(4-hydroxyphenyl)methane, 1,1-bis(4-hydroxyphenyl)ethane, 2,2-bis(4-hydroxyphenyl)propane [bisphenol A], 2,2-bis(4-hydroxyphenyl)butane, 2,2-bis(4-hydroxyphenyl)octane, bis(4-hydroxyphenyl)phenylmethane, bis(4-hydroxyphenyl)diphenylmethane, 2,2-bis(4-hydroxy-3-methylphenyl)propane, bis(4-hydroxyphenyl) naphthylmethane, 1,1-bis(4-hydroxy-3-t-butylphenyl)propane, 2,2-bis(4-hydroxy-3-bromophenyl)propane, 2,2-bis(4-hydroxy-3,5-dimethylphenyl)propane, 2,2-bis(4-hydroxy-3-chlorophenyl)propane, 2,2-bis(4-hydroxy-3,5-dichlorophenyl)propane, and 2,2-bis(4-hydroxy-3,5-dibromophenyl)propane.

Examples of the bis(hydroxyaryl)cycloalkanes include 1,1-bis(4-hydroxyphenyl)cyclopentane, 1,1-bis(4-hydroxyphenyl)cyclohexane, 1,1-bis(4-hydroxyphenyl)-3,5,5-trimethylcyclohexane, 2,2-bis(4-hydroxyphenyl)norbornane, and 1,1-bis(4-hydroxyphenyl)cyclododecane. Examples of the dihydroxyaryl ethers include 4,4′-dihydroxydiphenyl ether and 4,4′-dihydroxy-3,3′-dimethylphenyl ether.

Examples of the dihydroxydiaryl sulfides include 4,4′-dihydroxydiphenyl sulfide and 4,4′-dihydroxy-3,3′-dimethyldiphenyl sulfide. Examples of the dihydroxydiaryl sulfoxides include 4,4′-dihydroxydiphenyl sulfoxide and 4,4′-dihydroxy-3,3′-dimethyldiphenyl sulfoxide. Examples of the dihydroxydiaryl sulfones include 4,4′-dihydroxydiphenyl sulfone and 4,4′-dihydroxy-3,3′-dimethyldiphenyl sulfone.

An example of the dihydroxydiphenyls is 4,4′-dihydroxydiphenyl. Examples of the dihydroxydiarylfluorenes include 9,9-bis(4-hydroxyphenyl) fluorene and 9,9-bis(4-hydroxy-3-methylphenyl)fluorene. Examples of the dihydroxydiaryladamantanes include 1,3-bis(4-hydroxyphenyl)adamantane, 2,2-bis(4-hydroxyphenyl)adamantane, and 1,3-bis(4-hydroxyphenyl)-5,7-dimethyladamantane.

Examples of the dihydric phenol other than the above dihydric phenols include 4,4′-[1,3-phenylenebis(1-methylethylidene)]bisphenol, 10,10-bis(4-hydroxyphenyl)-9-anthrone, and 1,5-bis(4-hydroxyphenylthio)-2,3-dioxapentane.

Among them, as the dihydric phenol, bis(hydroxyaryl)alkanes are preferred, bis(hydroxyphenyl)alkanes are more preferred, and bisphenol A is still more preferred. When bisphenol A is used as the dihydric phenol, X¹ represents an isopropylidene group and a relationship of a=b=0 is satisfied in the general formula (i).

The carbonate precursor is, for example, one or more selected from the group consisting of dimethyl carbonate, diethyl carbonate, dibutyl carbonate, dicyclohexyl carbonate, diphenyl carbonate, ditolyl carbonate, bis(chlorophenyl) carbonate, di-m-cresyl carbonate, dinaphthyl carbonate, bis(diphenyl) carbonate, phosgene, triphosgene, diphosgene, bromophosgene, and bishaloformate. Among them, from the viewpoint that the precursor is used in the interfacial polymerization method, one or more selected from the group consisting of phosgene and triphosgene are preferred, and phosgene is more preferred.

The siloxane compound represented by the following general formula (ii) is a raw material forming the constituent unit (A-2) represented by the general formula (II) in the PC-POS copolymer (A):

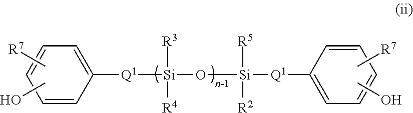

wherein R³ to R⁷, Q¹, and “n” are identical to those described above.

The siloxane compound represented by the general formula (ii) is preferably, for example, a compound represented by the following formula (ii-1)

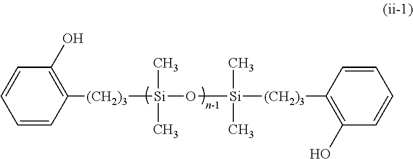

wherein “n” is identical to that described above.

The siloxane compound represented by the following general formula (iii) is a raw material forming the constituent unit (A-3) represented by the general formula (III) in the PC-POS copolymer (A):

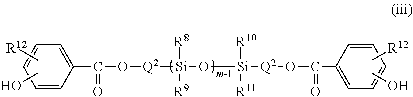

wherein R⁸ to R¹², Q², and “m” are identical to those described above.

The siloxane compound represented by the general formula (iii) is preferably, for example, a compound represented by the following formula (iii-1):

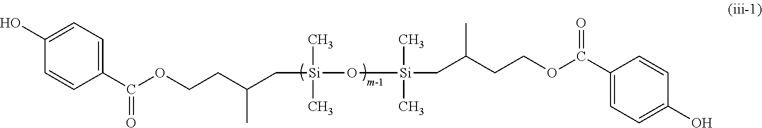

wherein “m” is identical to that described above.

The siloxane compound represented by the general formula (ii) or (iii) (hereinafter sometimes referred to as “terminal-modified polyorganosiloxane”) can be produced through, for example, (a) the stage at which an organodisiloxane and an organocyclosiloxane are caused to react with each other in the presence of an acid catalyst to produce a terminal-unmodified polyorganosiloxane, and (b) the stage at which the terminal-unmodified polyorganosiloxane is caused to react with a modifier in the presence of a metal catalyst to produce the terminal-modified polyorganosiloxane.

The organodisiloxane to be used in the reaction of the stage (a) is, for example, one or more selected from the group consisting of tetramethyldisiloxane, tetraphenyldisiloxane, hexamethyldisiloxane, and hexaphenyldisiloxane. In addition, an example of the organocyclosiloxane is an organocyclotetrasiloxane. Examples of the organocyclotetrasiloxane include octamethylcyclotetrasiloxane and octaphenylcyclotetrasiloxane.

The usage amount of the organodisiloxane falls within the range of preferably from 0.1 part by mass to 10 parts by mass, more preferably from 2 parts by mass to 8 parts by mass with respect to 100 parts by mass of the organocyclosiloxane.

The acid catalyst is not particularly limited as long as the acid catalyst used in polyorganosiloxane synthesis, and the catalyst is, for example, one or more selected from the group consisting of H₂SO₄, HClO₄, AlCl₃, SbCl₅, SnCl₄, and acidic clay.

The acid catalyst can be used in an amount in the range of preferably from 0.1 part by mass to 10 parts by mass, more preferably from 0.5 part by mass to 5 parts by mass, still more preferably from 1 part by mass to 3 parts by mass with respect to 100 parts by mass of the organocyclosiloxane.

In the reaction of the stage (b), the terminal-unmodified polyorganosiloxane produced by the reaction of the stage (a) is caused to react with the modifier in the presence of the metal catalyst to produce the terminal-modified polyorganosiloxane.

The metal catalyst to be used in the reaction of the stage (b) is not particularly limited as long as the metal catalyst used in the terminal modification reaction of a polyorganosiloxane, and the catalyst is, for example, a Pt catalyst.

The Pt catalyst is, for example, one or more selected from the group consisting of an Ashby catalyst, a Karstedt catalyst, a Lamoreaux catalyst, a Speier catalyst, PtCl₂(COD), PtCl₂ (benzonitrile)₂, and H₂PtBr₆.

The metal catalyst can be used in an amount in the range of preferably from 0.001 part by mass to 1 part by mass, more preferably from 0.005 part by mass to 0.1 part by mass, still more preferably from 0.01 part by mass to 0.05 part by mass with respect to 100 parts by mass of the polyorganosiloxane.

In the case of the siloxane compound represented by the general formula (ii), a compound represented by the following general formula (ii-2) can be used as the modifier, and in the case of the siloxane compound represented by the general formula (iii), a compound represented by the following general formula (iii-2) can be used as the modifier:

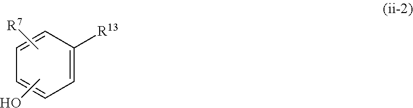

wherein R⁷ is identical to that described above, and R¹³ represents an alkenyl group having 2 to 10 carbon atoms;

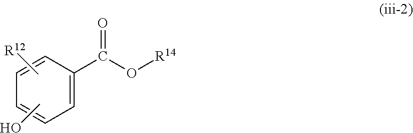

wherein R¹² is identical to that described above, and R¹⁴ represents an alkenyl group having 2 to 10 carbon atoms.

In the general formula (ii-2), R¹³ preferably represents an alkenyl group having 2 to 6 carbon atoms, more preferably represents an alkenyl group having 2 to 4 carbon atoms, and still more preferably represents an allyl group.

In the general formula (iii-2), R¹⁴ preferably represents an alkenyl group having 2 to 6 carbon atoms, more preferably represents an alkenyl group having 2 to 5 carbon atoms, and still more preferably represents a 2-methyl-1-butenyl group.

The modifier can be used in an amount in the range of preferably from 0.1 part by mass to 20 parts by mass, more preferably from 1 part by mass to 15 parts by mass, still more preferably from 5 parts by mass to 12 parts by mass with respect to 100 parts by mass of the polyorganosiloxane.

The reaction of the stage (a) is typically performed at from 50° C. to 70° C. for from 1 hour to 6 hours, though conditions therefor are not particularly limited. In addition, the reaction of the stage (b) is typically performed at from 80° C. to 100° C. for from 1 hour to 5 hours, though conditions therefor are not particularly limited.

In the production of the PC-POS copolymer (A), a terminal stopper can be used for adjusting the molecular weight of the PC-POS copolymer (A) to be obtained. As the terminal stopper, there is given a monoalkylphenol, for example, one or more selected from the group consisting of p-tert-butylphenol, p-cumylphenol, decylphenol, dodecylphenol, tetradecylphenol, hexadecylphenol, octadecylphenol, eicosylphenol, docosylphenol, and triacontylphenol. Among them, p-tert-butylphenol is preferred. The terminal stoppers may be used alone or in combination thereof.

From the viewpoint that a PC-POS copolymer having a desired molecular weight is obtained, the usage amount of the terminal stopper falls within the range of preferably from 0.01 part by mass to 10 parts by mass, more preferably from 0.1 part by mass to 6 parts by mass, still more preferably from 1 part by mass to 5 parts by mass with respect to 100 parts by mass of the dihydric phenol represented by the general formula (i).

The interfacial polymerization method is preferably used in the production of the PC-POS copolymer (A). In this case, the polymerization of the copolymer can be performed at normal pressure and low temperature, and the control of the molecular weight thereof is facilitated. The interfacial polymerization is performed by, for example, causing the dihydric phenol, the carbonate precursor, and the siloxane compounds to react with each other in the presence of an alkali compound and an organic solvent.

The interfacial polymerization preferably includes the following step: after the respective components have been preliminarily polymerized, a coupling agent is loaded into the resultant, and then the mixture is polymerized again. In this case, a PC-POS copolymer having a high molecular weight can be obtained.

The alkali compound is, for example, an alkali metal hydroxide, such as sodium hydroxide or potassium hydroxide, or an amine compound, such as pyridine. In addition, the organic solvent is not particularly limited as long as the solvent typically used in the polymerization of a polycarbonate, and the solvent is, for example, a halogenated hydrocarbon, such as methylene chloride or chlorobenzene.

In addition, such coupling agents as described below can each be further used at the time of the interfacial polymerization: tertiary amine compounds, such as triethylamine, tetra-n-butylammonium bromide, and tetra-n-butylphosphonium bromide; quaternary ammonium compounds; and quaternary phosphonium compounds.

A temperature at the time of the interfacial polymerization is preferably from 0° C. to 40° C., and a reaction time is preferably from 10 minutes to 5 hours. A pH during the reaction is maintained at preferably 9 or more, more preferably 11 or more.

The molecular weight modifier described above may be further added at the time of the interfacial polymerization reaction. The molecular weight modifier can be loaded before the initiation of the polymerization, during the initiation of the polymerization, or after the initiation of the polymerization.

After the interfacial polymerization, the resultant is appropriately left at rest to be separated into an aqueous phase and an organic solvent phase. The organic solvent phase is washed (preferably washed with a basic aqueous solution, an acidic aqueous solution, and water in order), and the resultant organic phase is concentrated and dried. Thus, the PC-POS copolymer can be obtained.

### (Method of Producing Polycarbonate-Based Resin (B))

A method of producing the polycarbonate-based resin (B) is not particularly limited, and a known method can be used.

The aromatic polycarbonate-based resin to be preferably used as the polycarbonate-based resin (B) can be obtained by, for example, a conventional polycarbonate production method, such as: an interfacial polymerization method involving causing a dihydric phenol and phosgene to react with each other in the presence of an organic solvent inert to the reaction and an alkaline aqueous solution, then adding a polymerization catalyst, such as a tertiary amine or a quaternary ammonium salt, to the resultant, and polymerizing the mixture; or a pyridine method involving dissolving the dihydric phenol in pyridine or a mixed solution of pyridine and an inert solvent, and introducing phosgene into the solution to directly produce the resin. A molecular weight modifier (terminal stopper), a branching agent, or the like is used as required at the time of the reaction.

The dihydric phenol is, for example, a dihydric phenol represented by the following general formula (iv):

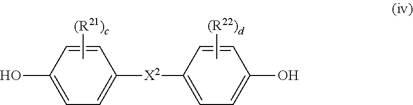

wherein R²¹, R²², “c”, “d”, and X² are identical to those described above.

Specific examples of the dihydric phenol may include those described above in the method of producing the PC-POS copolymer (A), and preferred examples thereof are also the same as those described above. Among them, bis(hydroxyphenyl)alkanes are preferred, and bisphenol A is more preferred.

### <Content of Each Component>

The polycarbonate-based resin composition of the present invention includes: 99 mass % to 1 mass % of the polycarbonate-polyorganosiloxane copolymer (A); and 1 mass % to 99 mass % of the polycarbonate-based resin (B) except the PC-POS copolymer (A). When the content of the PC-POS copolymer (A) in the resin composition is less than 1 mass %, the impact resistance of a molded article formed of the resin composition becomes insufficient, and when the content is more than 99 mass %, the composition is poor in economic efficiency.

From the above viewpoints, the content of the PC-POS copolymer (A) in the resin composition is preferably from 98 mass % to 2 mass %, more preferably from 95 mass % to 5 mass %, still more preferably from 90 mass % to 10 mass %, still further more preferably from 80 mass % to 10 mass %, still further more preferably from 70 mass % to 10 mass %, still further more preferably from 60 mass % to 15 mass %, still further more preferably from 50 mass % to 15 mass %. In addition, the content of the polycarbonate-based resin (B) in the resin composition is preferably from 2 mass % to 98 mass %, more preferably from 5 mass % to 95 mass %, still more preferably from 10 mass % to 90 mass %, still further more preferably from 20 mass % to 90 mass %, still further more preferably from 30 mass % to 90 mass %, still further more preferably from 40 mass % to 85 mass %, still further more preferably from 50 mass % to 85 mass %.

### <Other Component>

The resin composition of the present invention can be blended with any other additive to the extent that the effects of the present invention are not impaired. Examples of the other additive may include an antioxidant, a UV absorber, a flame retardant, a flame retardant auxiliary, a release agent, a reinforcing material, a filler, an elastomer for improving impact resistance, and a dye. Those additives may be used alone or in combination thereof. The resin composition of the present invention preferably includes the antioxidant among them from the viewpoint that the oxidative deterioration of the polycarbonate-based resin composition at the time of its melting can be prevented, and hence its coloring or the like due to the oxidative deterioration is prevented.

For example, a phosphorus-based antioxidant and/or a phenol-based antioxidant is suitably used as the antioxidant, and a phosphorus-based antioxidant is more preferred.

Examples of the phosphorus-based antioxidant include: phosphite compounds, such as triphenyl phosphite, diphenylnonyl phosphite, diphenyl(2-ethylhexyl) phosphite, tris(2,4-di-t-butylphenyl) phosphite, trisnonylphenyl phosphite, diphenylisooctyl phosphite, 2,2′-methylenebis(4,6-di-t-butylphenyl)octyl phosphite, diphenylisodecyl phosphite, diphenyl mono(tridecyl) phosphite, phenyl diisodecyl phosphite, phenyl di(tridecyl) phosphite, tris(2-ethylhexyl) phosphite, tris(isodecyl) phosphite, tris(tridecyl) phosphite, dibutyl hydrogen phosphite, trilauryl trithiophosphite, tetrakis(2,4-di-t-butylphenyl)-4,4′-biphenylene diphosphonite, 4,4′-isopropylidenediphenol dodecyl phosphite, 4,4′-isopropylidenediphenol tridecyl phosphite, 4,4′-isopropylidenediphenol tetradecyl phosphite, 4,4′-isopropylidenediphenol pentadecyl phosphite, 4,4′-butylidenebis(3-methyl-6-t-butylphenyl)ditridecyl phosphite, bis(2,4-di-t-butylphenyl)pentaerythritol diphosphite, bis(2,6-di-t-butyl-4-methylphenyl)pentaerythritol diphosphite, bis(nonylphenyl)pentaerythritol diphosphite, distearyl-pentaerythritol diphosphite, phenyl bisphenol A pentaerythritol diphosphite, tetraphenyl dipropylene glycol diphosphite, and 1,1,3-tris(2-methyl-4-di-tridecyl phosphite-5-t-butylphenyl)butane; and 3,4,5,6-dibenzo-1,2-oxaphosphane, triphenylphosphine, diphenylbutylphosphine, diphenyloctadecylphosphine, tris-(p-tolyl)phosphine, tris-(p-nonylphenyl)phosphine, tris-(naphthyl)phosphine, diphenyl-(hydroxymethyl)-phosphine, diphenyl-(acetoxymethyl)-phosphine, diphenyl-(β-ethylcarboxyethyl)-phosphine, tris-(p-chlorophenyl)phosphine, tris-(p-fluorophenyl)phosphine, diphenylbenzylphosphine, diphenyl-β-cyanoethylphosphine, diphenyl-(p-hydroxyphenyl)-phosphine, diphenyl-1,4-dihydroxyphenyl-2-phosphine, and phenylnaphthylbenzylphosphine. Those antioxidants may be used alone or in combination thereof.

Among those described above, in terms of an oxidative deterioration-preventing effect, a phosphite compound is preferred, and tris(2,4-di-t-butylphenyl) phosphite is more preferred.

Examples of the phenol-based antioxidant include hindered phenols, such as n-octadecyl-3-(3,5-di-t-butyl-4-hydroxyphenyl)propionate, 2,6-di-t-butyl-4-methylphenol, 2,2′-methylenebis(4-methyl-6-t-butylphenol), and pentaerythrityl-tetrakis[3-(3,5-di-t-butyl-4-hydroxyphenyl)propionate]. Those phenol-based antioxidants may be used alone or in combination thereof.

The blending amount of the antioxidant in the resin composition of the present invention is preferably 0.001 part by mass or more to 0.5 part by mass or less, more preferably 0.01 part by mass or more to 0.3 part by mass or less, still more preferably 0.02 part by mass or more to 0.2 part by mass or less with respect to 100 parts by mass of the total amount of the PC-POS copolymer (A) and the polycarbonate-based resin (B). When the content of the antioxidant falls within the range, a sufficient antioxidant action is obtained and the contamination of a die at the time of the molding of the composition can be suppressed.

The content of the polyorganosiloxane blocks in the resin composition of the present invention is preferably 0.1 mass % to 10 mass %, more preferably 0.2 mass % to 8.0 mass %, still more preferably 0.5 mass % to 6.0 mass %, still further more preferably 1.5 mass % to 4.5 mass %. When the content is 0.1 mass % or more, the impact resistance of the composition is satisfactory, and when the content is 10 mass % or less, the composition is excellent in transparency and economic efficiency.

The viscosity-average molecular weight (Mv) of the resin composition of the present invention is preferably from 9,000 to 50,000, more preferably from 12,000 to 30,000, still more preferably from 14,000 to 25,000, still further more preferably from 15,000 to 20,000. When the viscosity-average molecular weight of the resin composition falls within the range, the impact resistance and chemical resistance of the composition become sufficient, and the fluidity thereof at the time of its molding becomes excellent. The viscosity-average molecular weight can be measured by the method described above.

The polycarbonate-based resin composition of the present invention can be obtained by blending the PC-POS copolymer (A) and the polycarbonate-based resin (B), and, as required, the additive, and kneading the components.

The blending and the kneading can be performed by a method that has typically been used, for example, a method involving using a ribbon blender, a Henschel mixer, a Banbury mixer, a drum tumbler, a single-screw extruder, a twin-screw extruder, a Ko-kneader, or a multi-screw extruder.

A heating temperature at the time of the kneading is typically selected from the range of from 250° C. to 320° C.

### [Molded Body]

A molded body of the present invention includes the resin composition of the present invention described above, and is obtained by molding the resin composition. Various conventionally known molding methods, such as an injection molding method, an injection compression molding method, an extrusion molding method, a blow molding method, a press molding method, a vacuum molding method, and an expansion molding method, can each be used in the molding of the resin composition.

The resin composition and molded body of the present invention are each excellent in transparency, and a haze value of 3 mm thick plate produced from the present resin composition, measured in conformity with ISO 14782, is typically 0.8 or less, preferably 0.6 or less, more preferably 0.5 or less, still more preferably 0.4 or less.

In addition, a total light transmittance of 3 mm thick plate produced from the present resin composition, measured in conformity with ISO 14782, is typically 87% or more, preferably 88% or more, more preferably 88.5% or more.

The haze value and the total light transmittance are specifically measured by methods described in Examples.

The resin composition and molded body of the present invention are each excellent in impact resistance, and a notched test piece (having a thickness of 3.2 mm) produced from the resin composition or the molded body has an Izod impact strength at −30° C. measured in conformity with ASTM D256 of typically 20 kJ/m² or more, preferably 25 kJ/m² or more, more preferably 50 kJ/m² or more. The Izod impact strength is specifically measured by a method described in Examples.

The resin composition and the molded body of the present invention can be suitably used in, for example, parts for electrical and electronic equipment, such as a television, a radio-cassette player, a digital camera, a video camera, a videotape recorder, an audio player, a DVD player, an air conditioner, a cellular phone, a display, a computer, a register, an electronic calculator, a copying machine, a printer, or a facsimile, or casings for the electrical and electronic equipment, parts for the interior and exterior of lighting equipment, parts for the interior and exterior of a vehicle, electric tools, food trays, and eating utensils. In particular, the resin composition and the molded body are each suitable as a material fora casing for a cellular phone, a mobile personal computer, a digital camera, a video camera, an electric tool, or the like.

### EXAMPLES

Next, the present invention is described more specifically by way of Examples. However, the present invention is by no means limited by these examples. Characteristic values and evaluation results in the respective examples were determined in accordance with the following procedures.

### <Measurement of Chloroformate Group Concentration>

10 mL of a polycarbonate oligomer solution was collected in a 200 mL Erlenmeyer flask with a volumetric pipette. The inside of the volumetric pipette was washed with 20 mL of methylene chloride, and the washing liquid was also loaded into the Erlenmeyer flask.

About 10 mL of a NaOH-MeOH solution (prepared by dissolving 36 g of sodium hydroxide in 39 mL of pure water to prepare 48 mass % aqueous NaOH, and loading and dissolving the aqueous solution in 500 mL of methanol) was loaded into the Erlenmeyer flask, and was stirred for 3 minutes so that a chloroformate group was hydrolyzed.

Further, 10 mL of deionized water was added to the resultant, and it was confirmed that a state in which no precipitate was present in the Erlenmeyer flask was established.

While the contents in the Erlenmeyer flask were stirred, a 1 mol/L aqueous solution of nitric acid (manufactured by Junsei Chemical Co., Ltd., normal solution for volumetric analysis) was gradually added to the contents. While the pH of the mixture was determined with universal pH test paper, the pH was adjusted to from 6 to 7 by neutralization.

Three droplets of a uranine solution (prepared by dissolving 0.1 g of uranine (manufactured by Kanto Chemical Co., Inc.) in 20 mL of ethanol) were loaded into the Erlenmeyer flask, and the development of a yellow color was observed. After that, while the contents in the Erlenmeyer flask were stirred, a 1 mol/L aqueous solution of silver nitrate (for volumetric analysis, manufactured by Wako Pure Chemical Industries, Ltd., f=1.001) was dropped with a burette. A dropping amount when the color of the contents in the Erlenmeyer flask changed from yellow to pink was recorded.

A chloroformate group concentration (CF) was determined from the following calculation equation:

CF=dropping amount (mL) of 1 mol/L silver nitrate×f×1/10

where f=1.001 (factor of the aqueous solution of silver nitrate).

### <Chain Length and Content of Polydimethylsiloxane>

The chain length and content of a polydimethylsiloxane were calculated by NMR measurement from the integrated value ratio of a methyl group of the polydimethylsiloxane.

### (Quantification Method for Chain Length of Polydimethylsiloxane)

### 1H-NMR Measurement Conditions

NMR apparatus: ECA-500 manufactured by JEOL Resonance Inc.

### Probe: 50TH5AT/FG2

Observed range: −5 ppm to 15 ppm
Observation center: 5 ppm
Pulse repetition time: 9 sec
Pulse width: 45°
NMR sample tube: 5 φ
Sample amount: 30 mg to 40 mg
Solvent: deuterochloroform
Measurement temperature: room temperature
Number of scans: 256 times

### [Allylphenol-Terminated Polydimethylsiloxane]

A: an integrated value of a methyl group in a dimethylsiloxane moiety observed around δ −0.02 to δ 0.5
B: an integrated value of a methylene group in allylphenol observed around δ 2.50 to δ 2.75
Chain length of polydimethylsiloxane=(A/6)/(B/4)

### [Eugenol-Terminated Polydimethylsiloxane]

A: an integrated value of a methyl group in a dimethylsiloxane moiety observed around δ −0.02 to δ 0.5
B: an integrated value of a methylene group in eugenol observed around δ 2.40 to δ 2.70
Chain length of polydimethylsiloxane=(A/6)/(B/4)

### [Polydimethylsiloxane Having Allylphenol Terminal and 2-Methyl-1-Butene Hydroxybenzoate (MBHB) Terminal]

A: an integrated value of a methyl group in a dimethylsiloxane moiety observed around δ −0.02 to δ 0.5
B: an integrated value of a methylene group in allylphenol observed around δ 2.50 to δ 2.75
C: an integrated value of a methylene group in 2-methyl-1-butene hydroxybenzoate observed around δ 2.40 to δ 2.70
Chain length of polydimethylsiloxane=(A/6)/(B/4+C/4)

### (Quantification Method for Content of Polydimethylsiloxanein PC-POS Copolymer)

Quantification Method for Content of Polydimethylsiloxane in p-t-Butylphenol (PTBP)-terminated Polycarbonate obtained by copolymerizing Allylphenol-terminated Polydimethylsiloxane NMR apparatus: ECA-500 manufactured by JEOL Resonance Inc.

Probe: TH5 corresponding to 5 φ NMR sample tube
Observed range: −5 ppm to 15 ppm
Observation center: 5 ppm
Pulse repetition time: 9 sec
Pulse width: 45°
Number of scans: 256 times
NMR sample tube: 5 φ
Sample amount: 30 mg to 40 mg
Solvent: deuterochloroform
Measurement temperature: room temperature
A: an integrated value of a methyl group in a bisphenol A (BPA)
moiety observed around δ 1.5 to δ 1.9
B: an integrated value of a methyl group in a dimethylsiloxane moiety
observed around δ −0.02 to δ 0.5
C: an integrated value of a butyl group in a p-tert-butylphenyl moiety observed around δ 1.2 to δ 1.4
a=A/6
b=B/6
c=C/9

### T=a+b+c

f=a/T×100
g=b/T×100
h=c/T×100
TW=f×254+g×74.1+h×149
PDMS (mass %)=g×74.1/TW×100

The content of a polydimethylsiloxane in a PC-POS copolymer except that described above can also be measured by the same method.

(Quantification Method for Molar Ratio Between Allylphenol Unit (q-1) and MBHB Unit (q-2) in PTBP-Terminated Polycarbonate Obtained by Copolymerizing Allylphenol-Terminated Polydimethylsiloxane and MBHB-Terminated Polydimethylsiloxane)
NMR apparatus: ECA-500 manufactured by JEOL Resonance Inc.
Probe: TH5 corresponding to 5 φ NMR sample tube
Observed range: −5 ppm to 15 ppm
Observation center: 5 ppm
Pulse repetition time: 9 sec
Pulse width: 45°
Number of scans: 256 times
NMR sample tube: 5 φ
Sample amount: 30 mg to 40 mg
Solvent: deuterochloroform
Measurement temperature: room temperature
A: an integrated value of a methylene group in allylphenol observed around δ 2.50 to δ 2.75
B: an integrated value of a methylene group in 2-methyl-1-butene hydroxybenzoate observed around δ 4.25 to δ 4.45
a=A/2
b=B/2

### T=a+b

(mol %)=a/T×100 Formula q-1

(mol %)=b/T×100 Formula q-2

### <Viscosity-Average Molecular Weight>

A viscosity-average molecular weight (Mv) was calculated from the following equation (Schnell's equation) by using a limiting viscosity [η] determined through the measurement of the viscosity of a methylene chloride solution (concentration: g/L) at 20° C. with an Ubbelohde-type viscometer.

[η]=1.23×10⁻⁵×Mv^{0.83}

### [Evaluation Test]

### <MFR>

A MFR (g/10 min) at a temperature of 300° C. and a load of 1.2 kg was measured in conformity with ISO 1133.

<Q Value (Flow Value) [Unit; 10⁻² mL/sec]>

The amount (×10⁻² mL/sec) of a molten resin flowing out of a nozzle having a diameter of 1 mm and a length of 10 mm was measured in conformity with JIS K7210-1:2014 with a Koka flow tester at 280° C. under a pressure of 160 kg. A Q value represents an outflow per unit time, and a higher numerical value means that the fluidity of the resin is more satisfactory.

### <Tensile Test>

A test piece having a length of 174 mm and a thickness of 3.2 mm in which a parallel portion measured 60 mm long by 10 mm wide was used, and its tensile yield strength and tensile elongation were measured in conformity with ASTM D638 under the condition of a tensile rate of 10 mm/min. Larger numerical values mean that the tensile characteristics of the test piece are more satisfactory.

### <Bending Test>

A test piece measuring 100 mm by 10 mm by 4 mm thick was used, and its bending strength and bending modulus were measured in conformity with ASTM D790 under the conditions of a temperature of 23° C. and a bending rate of 2 mm/min. Larger numerical values mean that the bending characteristics of the test piece are more satisfactory.

### <Heat Distortion Temperature (HDT)>

A test piece for a HDT to be described later was used, and its heat distortion temperature (HDT) was measured in conformity with ASTM D648 at a load of 1.83 MPa. The HDT serves as a guideline on heat resistance, and a judgement criterion therefor is as follows: a HDT of 120° C. or more means that the test piece has sufficient heat resistance.

### <Izod Impact Strength>

A test piece obtained by making a notch in a test piece for performing an Izod test to be described later through post-processing was used, and its notched Izod impact strengths at 23° C., −30° C., and −40° C. were measured in conformity with ASTM D256.

### <Total Light Transmittance and Haze>

A total light transmittance and a haze were each measured by using a test piece to be described later (3-millimeter thick portion of a 3-stage plate) in conformity with ISO 14782, and the average of 5 measured values was determined. A haze meter “NDH 2000” manufactured by Nippon Denshoku Industries Co., Ltd. was used as a measuring apparatus.

### Production Example 1 (Production of Polycarbonate Oligomer)

Sodium dithionite was added in an amount of 2,000 ppm with respect to bisphenol A (BPA) to be dissolved later to 5.6 mass % aqueous sodium hydroxide, and bisphenol A was dissolved in the mixture so that the concentration of bisphenol A was 13.5 mass %. Thus, a solution of bisphenol A in aqueous sodium hydroxide was prepared.

The solution of bisphenol A in aqueous sodium hydroxide, methylene chloride, and phosgene were continuously passed through a tubular reactor having an inner diameter of 6 mm and a tube length of 30 m at flow rates of 40 L/hr, 15 L/hr, and 4.0 kg/hr, respectively.

The tubular reactor had a jacket portion and the temperature of a reaction liquid was kept at 40° C. or less by passing cooling water through the jacket.

The reaction liquid that had exited the tubular reactor was continuously introduced into a baffled vessel-type reactor having an internal volume of 40 L provided with a sweptback blade, and then the solution of bisphenol A in aqueous sodium hydroxide, 25 mass % aqueous sodium hydroxide, water, and a 1 mass % aqueous solution of triethylamine were further added to the reactor at flow rates of 2.8 L/hr, 0.07 L/hr, 17 L/hr, and 0.64 L/hr, respectively, to thereby perform a reaction.

The reaction liquid flowing out of the vessel-type reactor was continuously taken out, and then an aqueous phase was separated and removed by leaving the liquid at rest, followed by the collection of a methylene chloride phase.

The concentration of the polycarbonate oligomer thus obtained was 338 g/L and the concentration of a chloroformate group thereof was 0.70 mol/L.

### Production Example 2 (Production of Polycarbonate-Polydimethylsiloxane Copolymer (a1))

15 L of the polycarbonate oligomer solution produced in Production Example 1 described above, 7.7 L of methylene chloride, 390 g of an o-allylphenol terminal-modified polydimethylsiloxane (PDMS) in which the average chain length n of a polydimethylsiloxane was 40, and 8.3 mL of triethylamine were loaded into a 50-liter vessel-type reactor including a baffle board, a paddle-type stirring blade, and a cooling jacket. 1,389 g of aqueous sodium hydroxide prepared by dissolving 84 g of sodium hydroxide in 966 mL of pure water was added to the mixture under stirring to perform a reaction between the polycarbonate oligomer and the allylphenol terminal-modified PDMS for 20 minutes.

A solution of p-t-butylphenol (PTBP) in methylene chloride (prepared by dissolving 145 g of PTBP in 2.0 L of methylene chloride) and a solution of bisphenol A in aqueous sodium hydroxide (prepared by dissolving 1,029 g of bisphenol A in an aqueous solution prepared by dissolving 546 g of sodium hydroxide and 2.1 g of sodium dithionite in 8.0 L of pure water) were added to the polymerization liquid to perform a polymerization reaction for 40 minutes.

13 L of methylene chloride was added to the resultant for dilution and the mixture was stirred for 20 minutes. After that, the mixture was separated into an organic phase containing a polycarbonate-polydimethylsiloxane copolymer (PC-PDMS copolymer), and an aqueous phase containing excess amounts of bisphenol A and sodium hydroxide, and the organic phase was isolated.

The solution of the PC-PDMS copolymer in methylene chloride thus obtained was sequentially washed with 0.03 mol/L aqueous sodium hydroxide and 0.2 mol/L hydrochloric acid in amounts of 15 vol % each with respect to the solution. Next, the solution was repeatedly washed with pure water until an electric conductivity in an aqueous phase after the washing became 5 μS/cm or less.

The solution of the PC-PDMS copolymer in methylene chloride obtained by the washing was concentrated and pulverized, and the resultant flake was dried under reduced pressure at 120° C. to produce a PC-PDMS copolymer (a1).

The resultant PC-PDMS copolymer (a1) had a PDMS chain length (average chain length) determined by NMR of 37, a PDMS block moiety content of 6.0 mass %, a viscosity number measured in conformity with ISO 1628-4 (1999) of 47.5, and a viscosity-average molecular weight Mv of 17,700.

### Examples 1 to 8, Comparative Examples 1 to 11, and Reference Examples 1 to 4

Respective components were mixed at ratios shown in Table 1 and Table 2. Each of the mixtures was supplied to a vented twin-screw extruder (TEM-35B manufactured by Toshiba Machine Co., Ltd.), and was melt-kneaded at a screw revolution number of 150 rpm, an ejection amount of 20 kg/hr, and a resin temperature of from 295° C. to 300° C. to provide an evaluation pellet sample. The evaluation pellet sample was dried at 120° C. for 8 hours, and was then subjected to injection molding with an injection molding machine (“NEX110” manufactured by Nissei Plastic Industrial Co., Ltd., screw diameter: 36 mmφ) at a cylinder temperature of 280° C. and a die temperature of 80° C. to produce test pieces for performing an Izod test (2 test pieces each measuring 63 mm by 13 mm by 3.2 mm thick) and a test piece for a HDT (measuring 126 mm by 13 mm by 3.2 mm thick).

Further, the dried evaluation pellet sample was subjected to injection molding with an injection molding machine (“MD50XB” manufactured by Niigata Machine Techno Co., Ltd., screw diameter: 30 mmφ) to produce a test piece for performing the measurement of a total light transmittance and a haze (3-stage plate: 90 mm×50 mm, 3-millimeter thick portion: 45 mm×50 mm, 2-millimeter thick portion: 22.5 mm×50 mm, 1-millimeter thick portion: 22.5 mm×50 mm).

The evaluations were performed by using the produced test pieces. The results are shown in Table 1 and Table 2.

### <Polycarbonate-Polyorganosiloxane Copolymer (A)>

(A1): A polycarbonate-polydimethylsiloxane [manufactured by LG Chem Ltd., LUPOY PC 8000-05 (product name), viscosity-average molecular weight: 21,100, PDMS chain length (average chain length): 36, PDMS block moiety content: 6.3 mass %, the polycarbonate-polydimethylsiloxane has the following repeating unit (A-1a), and the following constituent units (A-2a) and (A-3a), and a molar ratio between an allylphenol unit in the unit (A-2a) and an MBHB unit in the unit (A-3a) in the polycarbonate-polydimethylsiloxane (A1) is 97/3]

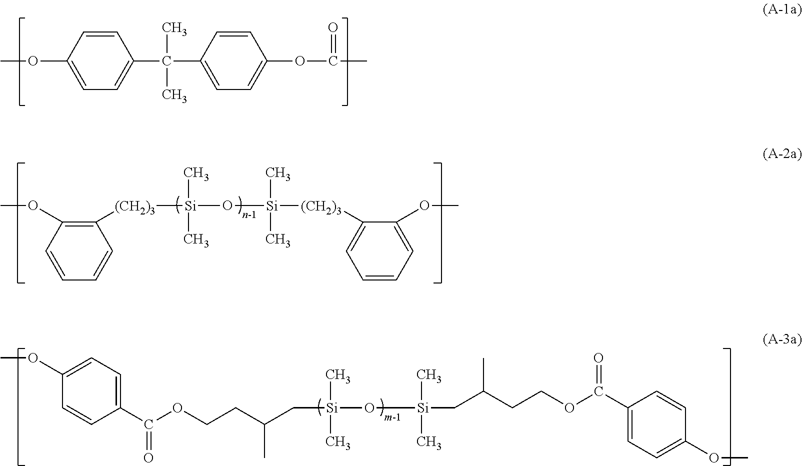

### <Polycarbonate-Polyorganosiloxane Copolymer Except (A)>

(a1): The PC-PDMS copolymer produced in Production Example 2 (copolymer having only the repeating unit (A-1a) and the constituent unit (A-2a))

(a2): A polycarbonate-polydimethylsiloxane [manufactured by SABIC Innovative Plastics, EXL1414T (product name), viscosity-average molecular weight: 18,300, PDMS chain length (average chain length): 43, PDMS block moiety content: 4.9 mass %, copolymer having only the repeating unit (A-1a) and the following constituent unit (A-2b)]

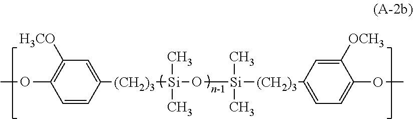

### <Polycarbonate-Based Resin (B) Except (A)>

FN1500: An aromatic (bisphenol A) homopolycarbonate resin [manufactured by Formosa Idemitsu Petrochemical Corp., TARFLON FN1500 (product name), viscosity-average molecular weight=14,200]

FN1700: An aromatic (bisphenol A) homopolycarbonate resin [manufactured by Formosa Idemitsu Petrochemical Corp., TARFLON FN1700 (product name), viscosity-average molecular weight=17,700]

FN1900: An aromatic (bisphenol A) homopolycarbonate resin [manufactured by Formosa Idemitsu Petrochemical Corp., TARFLON FN1900 (product name), viscosity-average molecular weight=19,100]

FN2200: An aromatic (bisphenol A) homopolycarbonate resin [manufactured by Formosa Idemitsu Petrochemical Corp., TARFLON FN2200 (product name), viscosity-average molecular weight=21,200]

FN2500: An aromatic (bisphenol A) homopolycarbonate resin [manufactured by Formosa Idemitsu Petrochemical Corp., TARFLON FN2500 (product name), viscosity-average molecular weight=23,400]

### <Antioxidant>

Irg168: Tris(2,4-di-t-butylphenyl)phosphite [manufactured by BASF Japan, IRGAFOS 168 (product name)]

TABLE 1

| | | | | | Comparative | Comparative | | Comparative | Comparative | | Comparative | Comparative | |
|---|---|---|---|---|---|---|---|---|---|---|---|---|---|
| | | | Unit | Example 1 | Example 1 | Example 2 | Example 2 | Example 3 | Example 4 | Example 3 | Example 5 | Example 6 | |
| Resin | (A) | (A1) LUPOY PC 8000 05 | Part(s) by mass | 29 | | | 38 | | | 48 | | | |
| composition | PC-POS | (a1) PC-PDMS of | Part(s) by mass | | 30 | | | 40 | | | 50 | | |
| formulation | copolymer | Production Example 2 | | | | | | | | | | | |
| | except (A) | (a2) EXL14141 | Part(s) by mass | | | 37 | | | 49 | | | 61 | |
| | (B) | FN1500 | Part(s) by mass | 31 | | 9 | 40 | | 11 | 50 | | 12 | |
| | | FN1700 | Part(s) by mass | 40 | 70 | 54 | 22 | 60 | 40 | 2 | 50 | 27 | |
| | | FN1900 | Part(s) by mass | | | | | | | | | | |
| | | FN2200 | Part(s) by mass | | | | | | | | | | |
| | | FN2500 | Part(s) by mass | | | | | | | | | | |
| | Antioxidant | Irg168 | ppm | 500 | 500 | 500 | 500 | 500 | 500 | 500 | 500 | 500 | |
| PDMS chain length | | | — | 36 | 37 | 43 | 36 | 37 | 43 | 36 | 37 | 43 | |
| PDMS content in resin composition | | | mass % | 1.8 | 1.8 | 1.8 | 2.4 | 2.4 | 2.4 | 3.0 | 3.0 | 3.0 | |
| Mv of resin composition | | | — | 17,600 | 17,500 | 17,600 | 17,500 | 17,700 | 17,600 | 17,600 | 17,600 | 17,700 | |
| | | | | | Comparative | Comparative | | Comparative | Comparative | | Comparative | Comparative | |
| | | | Unit | Example 1 | Example 1 | Example 2 | Example 2 | Example 3 | Example 4 | Example 3 | Example 5 | Example 6 | |
| Evaluation | MFR (300° C., 1.2 kg) | | g/10 min | 21 | 21 | 21 | 19 | 20 | 19 | 17 | 18 | 17 | |
| result | Flow value (280° C., 160 kg) | | ×10⁻² mL/sec | 14 | 13 | 13 | 14 | 12 | 12 | 14 | 12 | 12 | |
| | Tensile yield strength | | MPa | 61 | 61 | 61 | 61 | 61 | 60 | 61 | 61 | 60 | |
| | Tensile elongation | | % | 95 | 107 | 110 | 94 | 86 | 108 | 102 | 97 | 101 | |
| | Bending strength | | MPa | 89 | 90 | 88 | 90 | 89 | 90 | 89 | 89 | 90 | |
| | Bending modulus | | MPa | 2,240 | 2,250 | 2,230 | 2,220 | 2,220 | 2,200 | 2,180 | 2,180 | 2,170 | |
| | Heat distortion temperature | | ° C. | 127 | 127 | 127 | 126 | 127 | 126 | 125 | 126 | 125 | |
| | (1.83 MPa) | | | | | | | | | | | | |
| | Izod impact strength (23° C.) | | kJ/m² | 80 | 83 | 85 | 79 | 83 | 83 | 82 | 84 | 86 | |
| | Izod impact strength (−30° C.) | | kJ/m² | 23 | 27 | 28 | 27 | 31 | 58 | 56 | 54 | 68 | |
| | Izod impact strength (−40° C.) | | kJ/m² | 21 | 21 | 22 | 20 | 23 | 26 | 22 | 24 | 29 | |
| | Total light transmittance | | % | 88.6 | 88.0 | 86.7 | 88.6 | 87.9 | 85.4 | 88.7 | 88.0 | 84.9 | |
| | (thickness 3 mm) | | | | | | | | | | | | |
| | Haze (thickness 3 mm) | | — | 0.5 | 0.7 | 1.2 | 0.4 | 0.8 | 1.0 | 0.4 | 0.7 | 1.0 | |
| | | | | | Comparative | | Comparative | | Comparative | | Comparative | | Comparative |
| | | | Unit | Example 4 | Example 7 | Example 5 | Example 8 | Example 6 | Example 9 | Example 7 | Example 10 | Example 8 | Example 11 |
| Resin | (A) | (A1) LUPOY PC 8000 05 | Part(s) by mass | 30 | | 48 | | 29 | | 38 | | 19 | |
| composition | PC-POS | (a1) PC-PDMS | Part(s) by mass | | 30 | | 50 | | 30 | | 40 | | 20 |
| formulation | copolymer | of Production | | | | | | | | | | | |
| | except (A) | Example 2 | | | | | | | | | | | |
| | | (a2) EXL1414T | Part(s) by mass | | | | | | | | | | |
| | (B) | FN1500 | Part(s) by mass | | | 3 | | | | | | | |
| | | FN1700 | Part(s) by mass | 9 | | 49 | 6 | | | | | | |
| | | FN1900 | Part(s) by mass | 61 | 46 | | 44 | | | | | | |
| | | FN2200 | Part(s) by mass | | 24 | | | 68 | 21 | 60 | | 32 | |
| | | FN2500 | Part(s) by mass | | | | | 3 | 49 | 2 | 60 | 49 | 80 |
| | Antioxidant | Irg168 | ppm | 500 | 500 | 500 | 500 | 500 | 500 | 500 | 500 | 500 | 500 |

| PDMS chain length | | — | 36 | 37 | 36 | 37 | 36 | 37 | 36 | 37 | 36 | 37 |
|---|---|---|---|---|---|---|---|---|---|---|---|---|
| PDMS content in resin composition | | mass % | 1.8 | 1.8 | 3.0 | 3.0 | 1.8 | 1.8 | 2.4 | 2.4 | 1.2 | 1.2 |
| Mv of resin composition | | — | 19,500 | 19,300 | 19,200 | 19,300 | 21,300 | 21,500 | 21,400 | 21,300 | 22,400 | 22,700 |
| | | | | Comparative | | Comparative | | Comparative | | Comparative | | Comparative |
| | | Unit | Example 4 | Example 7 | Example 5 | Example 8 | Example 6 | Example 9 | Example 7 | Example 10 | Example 8 | Example 11 |
| Evaluation | MFR (300° C., 1.2 kg) | g/10 min | 13 | 14 | 11 | 12 | 8.6 | 8.8 | 7.6 | 8.2 | 7.4 | 7.5 |
| result | Flow value (280° C., 160 kg) | ×10⁻² mL/sec | 8.1 | 8.5 | 8.5 | 8.2 | 5.0 | 5.1 | 5.2 | 5.3 | 4.1 | 4.0 |
| | Tensile yield strength | MPa | 61 | 61 | 60 | 61 | 61 | 61 | 61 | 61 | 61 | 61 |
| | Tensile elongation | % | 106 | 112 | 108 | 114 | 116 | 105 | 114 | 117 | 111 | 111 |
| | Bending strength | MPa | 90 | 90 | 89 | 89 | 89 | 89 | 89 | 88 | 89 | 90 |
| | Bending modulus | MPa | 2,290 | 2,300 | 2,250 | 2,260 | 2,280 | 2,290 | 2,260 | 2,270 | 2,300 | 2,300 |
| | Heat distortion temperature | ° C. | 127 | 127 | 125 | 126 | 128 | 128 | 127 | 128 | 130 | 130 |
| | (1.83 MPa) | | | | | | | | | | | |
| | Izod impact strength (23° C.) | kJ/m² | 85 | 84 | 80 | 83 | 95 | 95 | 90 | 96 | 93 | 98 |
| | Izod impact strength (−30° C.) | kJ/m² | 30 | 27 | 66 | 68 | 69 | 65 | 81 | 75 | 31 | 33 |
| | Izod impact strength (−40° C.) | kJ/m² | 23 | 23 | 34 | 28 | 26 | 27 | 38 | 29 | 22 | 22 |
| | Total light transmittance | % | 88.4 | 87.9 | 88.6 | 87.7 | 88.1 | 87.4 | 88.0 | 87.1 | 88.3 | 88.1 |
| | (thickness 3 mm) | | | | | | | | | | | |
| | Haze (thickness 3 mm) | — | 0.6 | 0.9 | 0.5 | 0.8 | 0.8 | 1.2 | 0.8 | 1.3 | 0.8 | 1.0 |

TABLE 2

| | | | | Reference | Reference | Reference | Reference |
|---|---|---|---|---|---|---|---|
| | | | Unit | Example 1 | Example 2 | Example 3 | Example 4 |
| Resin | (A) | (A1) LUPOY PC 8000 05 | Part(s) by mass | 100 | | | |
| composition | PC-POS copolymer | (a1) PC-PDMS of | Part(s) by mass | | 100 | | |
| formulation | except (A) | Production Example 2 | | | | | |
| | | (a2) EXL1414T | Part(s) by mass | | | 100 | |
| | (B) | FN1500 | Part(s) by mass | | | | |
| | | FN1700 | Part(s) by mass | | | | 100 |
| | | FN1900 | Part(s) by mass | | | | |
| | | FN2200 | Part(s) by mass | | | | |
| | | FN2500 | Part(s) by mass | | | | |
| | Antioxidant | Irg168 | ppm | — | 500 | — | 500 |

| PDMS chain length | | — | 36 | 37 | 43 | — |
|---|---|---|---|---|---|---|
| PDMS content in resin composition | | mass % | 6.3 | 6.0 | 4.9 | 0.0 |
| Mv of resin composition | | — | 21,100 | 17,700 | 18,300 | 17,700 |
| Evaluation | MFR (300° C., 1.2 kg) | g/10 min | 3.5 | 11 | 10 | 11 |
| result | Flow value (280° C., 160 kg) | ×10⁻² mL/sec | 4.8 | 12 | 12 | 12 |
| | Tensile yield strength | MPa | 59 | 60 | 58 | 60 |
| | Tensile elongation | % | 92 | 89 | 94 | 89 |
| | Bending strength | MPa | 84 | 87 | 85 | 87 |
| | Bending modulus | MPa | 2,070 | 2,120 | 2,140 | 2,120 |
| | Heat distortion temperature (1.83 MPa) | ° C. | 122 | 120 | 124 | 120 |
| | Izod impact strength (23° C.) | kJ/m² | 88 | 68 | 86 | 68 |
| | Izod impact strength (−30° C.) | kJ/m² | 85 | 54 | 69 | 54 |
| | Izod impact strength (−40° C.) | kJ/m² | 79 | 28 | 60 | 28 |
| | Total light transmittance (thickness 3 mm) | % | 89.0 | 89.0 | 84.9 | 89.0 |
| | Haze (thickness 3 mm) | — | 0.4 | 0.3 | 1.0 | 0.3 |

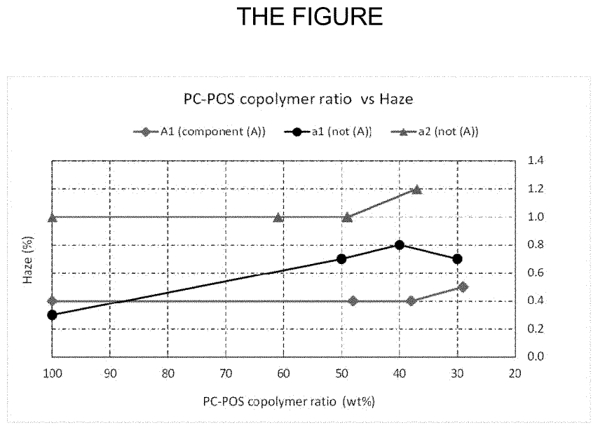

Here, a correlation between the mass % of the PC-POS copolymer of each of the resin compositions each having a viscosity-average molecular weight of around 17,500 (Examples 1 to 3, Comparative Examples 1, 3, and 5, and Comparative Examples 2, 4, and 6) and the haze thereof was plotted for each of PC-POS copolymer (FIG. 1). In FIG. 1, a haze in the case where a “PC-POS copolymer ratio” indicated by the axis of abscissa is 100 mass % corresponds to the haze of a PC-POS copolymer alone (Reference Examples 1 to 3).

According to FIG. 1, in the case of a PC-POS copolymer alone, the PC-POS copolymer (A1) corresponding to the component (A) in the present invention showed a haze comparable to that of the PC-POS copolymer (a1) obtained in Production Example 2. However, it is found that in a mixed system with a polycarbonate-based resin corresponding to the component (B) in the present invention, a resin composition using the PC-POS copolymer (A1) is superior in transparency to a resin composition using a copolymer except the copolymer (A1).

### INDUSTRIAL APPLICABILITY

According to the present invention, there can be provided a polycarbonate-based resin composition having high impact resistance and a low haze. The resin composition and molded body of the present invention can be suitably used in: parts for electrical and electronic equipment, such as a television, a radio-cassette player, a digital camera, a video camera, a videotape recorder, an audio player, a DVD player, an air conditioner, a cellular phone, a display, a computer, a register, an electronic calculator, a copying machine, a printer, and a facsimile; casings for these equipment; parts for the interior and exterior of lighting equipment; parts for the interior and exterior of a vehicle; electric tools; food trays; and eating utensils.

1. A polycarbonate-based resin composition, comprising:
99 mass % to 1 mass % of a polycarbonate-polyorganosiloxane copolymer (A) having a repeating unit (A-1) represented by the following general formula (I), a constituent unit (A-2) represented by the following general formula (II), and a constituent unit (A-3) represented by the following general formula (III); and
1 mass % to 99 mass % of a polycarbonate-based resin (B) except the polycarbonate-polyorganosiloxane copolymer (A): 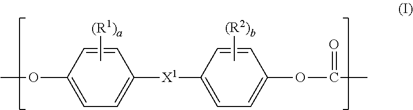
wherein R¹ and R² each independently represent a halogen atom, an alkyl group having 1 to 6 carbon atoms, or an alkoxy group having 1 to 6 carbon atoms, X¹ represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and “a” and “b” each independently represent an integer of from 0 to 4; 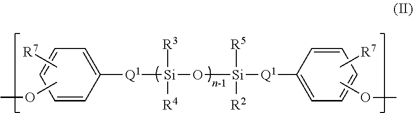
wherein R³ to R⁶ each independently represent a hydrogen atom or an alkyl group having 1 to 13 carbon atoms, R⁷ represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q¹ represents an alkylene group having 1 to 10 carbon atoms, and “n” represents an average chain length and represents from 30 to 70; 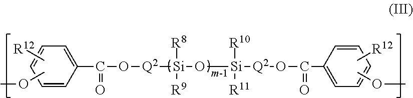
wherein R⁸ to R¹¹ each independently represent a hydrogen atom or an alkyl group having 1 to 13 carbon atoms, R¹² represents an alkyl group having 1 to 6 carbon atoms, a hydrogen atom, a halogen atom, a hydroxy group, an alkoxy group having 1 to 6 carbon atoms, or an aryl group having 6 to 14 carbon atoms, Q² represents a divalent aliphatic group having 1 to 10 carbon atoms, and “m” represents an average chain length and represents from 30 to 70.

2. The resin composition according to claim 1, wherein the polycarbonate-based resin (B) comprises an aromatic polycarbonate resin formed only of a repeating unit (B-1) represented by the following general formula (IV): 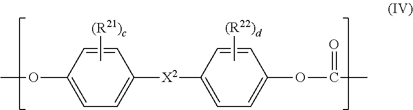
wherein R²¹ and R²² each independently represent a halogen atom, an alkyl group having 1 to 6 carbon atoms, or an alkoxy group having 1 to 6 carbon atoms, X² represents a single bond, an alkylene group having 1 to 8 carbon atoms, an alkylidene group having 2 to 8 carbon atoms, a cycloalkylene group having 5 to 15 carbon atoms, a cycloalkylidene group having 5 to 15 carbon atoms, a fluorenediyl group, an arylalkylene group having 7 to 15 carbon atoms, an arylalkylidene group having 7 to 15 carbon atoms, —S—, —SO—, —SO₂—, —O—, or —CO—, and “c” and “d” each independently represent an integer of from 0 to 4.

3. The resin composition according to claim 1, wherein the polycarbonate-polyorganosiloxane copolymer (A) has a viscosity-average molecular weight of from 9,000 to 50,000.

4. The resin composition according to claim 1, wherein the polycarbonate-based resin (B) has a viscosity-average molecular weight of from 9,000 to 50,000.

5. The resin composition according to claim 1, wherein the resin composition has a viscosity-average molecular weight of from 12,000 to 30,000.

6. The resin composition according to claim 1, wherein a content of polyorganosiloxane blocks in the polycarbonate-polyorganosiloxane copolymer (A) is from 1 mass % to 12 mass %.

7. The resin composition according to claim 1, wherein a content of polyorganosiloxane blocks in the resin composition is from 0.1 mass % to 10 mass %.

8. The resin composition according to claim 1, wherein a molar ratio between a unit represented by the following general formula (q-1) and a unit represented by the following general formula (q-2) in the polycarbonate-polyorganosiloxane copolymer (A) is from 99/1 to 85/15: 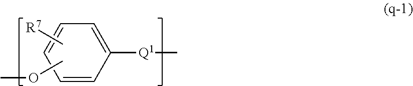
wherein R⁷ and Q¹ are identical to those described above; 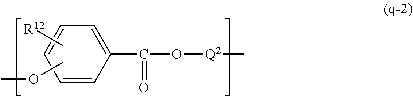
wherein R¹² and Q² are identical to those described above.

9. The resin composition according to claim 1, wherein in the general formula (I), X¹ represents an isopropylidene group and a=b=0.

10. The resin composition according to claim 1, wherein in the general formula (II), R³ to R⁶ each represent a methyl group.

11. The resin composition according to claim 1, wherein in the general formula (III), R⁸ to R¹¹ each represent a methyl group.

12. The resin composition according to claim 2, wherein in the general formula (IV), X² represents an isopropylidene group and c=d=0.

13. The resin composition according to claim 1, wherein a haze value of 3 mm thick plate produced from the resin composition, measured in conformity with ISO 14782, is 0.6 or less.

14. A molded body, comprising the resin composition of claim 1.
